(19) United States
(12) Patent Application Publication
(10) Pub. No.: US 2026/0030490 A1
(43) Pub. Date: Jan. 29, 2026

(54) ASYNCHRONOUS SPIKE COUNTING INTERFACE APPARATUS AND ASYNCHRONOUS SPIKE COUNTING METHOD IN SPIKE NEURAL NETWORK

(71) Applicant: ELECTRONICS AND TELECOMMUNICATIONS RESEARCH INSTITUTE, Daejeon (KR)

(72) Inventors: Kwang-Il OH, Daejeon (KR); Tae-Wook Kang, Daejeon (KR); Sung-Eun Kim, Daejeon (KR); Hyuk Kim, Daejeon (KR); Jae-Jin Lee, Daejeon (KR)

(73) Assignee: ELECTRONICS AND TELECOMMUNICATIONS RESEARCH INSTITUTE, Daejeon (KR)

(21) Appl. No.: 19/216,943

(22) Filed: May 23, 2025

(30) Foreign Application Priority Data
Jul. 29, 2024 (KR) 10-2024-0100488

(51) Int. Cl. G06N 3/049

(52) U.S. Cl. CPC G06N 3/049

(57) ABSTRACT

Disclosed herein are an asynchronous spike counting interface apparatus and an asynchronous spike counting method in a spike neural network. The asynchronous spike counting interface apparatus may include multiple counters, each counting the number of times each of neurons included in the spike neural network fires, and an address decoder for outputting an enable signal to the counter that counts the number of times the neuron corresponding to the address output from the spike neural network fires.

### CROSS REFERENCE TO RELATED APPLICATION

This application claims the benefit of Korean Patent Application No. 10-2024-0100488, filed Jul. 29, 2024, which is hereby incorporated by reference in its entirety into this application.

### BACKGROUND OF THE INVENTION

### 1. Technical Field

The disclosed embodiment relates to an asynchronous analog spike neural network circuit and technology for implementing a digital peripheral circuit including the asynchronous analog spike neural network circuit using a semiconductor.

### 2. Description of the Related Art

Spike neural networks are one of artificial intelligence network implementation methods for producing a series of outputs through network operations on applied input, and unlike operations of other networks, such as perceptron-based networks, convolution-based networks, etc., operations are performed by delivering input and signals in the form of pulses or spikes with very short duration, rather than in the form of certain numerical values. More specifically, when pulses at specific intervals, e.g., intermittent (aperiodic) or periodic spikes, are applied as the input (axons) of a network, a network operation based on the input is performed in a specific node, and the spike is delivered to the subsequent node (or the subsequent spike neural network) along a preset spike delivery path.

Here, elements that perform network operations based on spike input are broadly composed of two elements: synapses and neurons.

First, a synapse applies a synaptic weight of a corresponding node to a spike applied from the input (axon) and delivers the result to the input (dendrite) to the neuron to which the synapse is connected. Multiple synapses may be connected to the dendrites of the neuron, and spikes from multiple different axons are processed depending on the weights stored in the respective synapses and delivered to the dendrites of the identical neuron.

Subsequently, the results of the synaptic operations delivered to the neuron form a membrane potential by being integrated in a membrane where the dendrites are gathered, and when the integrated potential exceeds a threshold for firing of the neuron, the neuron fires and outputs a short pulse, that is, a spike. Summarizing the above-described mechanism, spikes respectively input to multiple axons are delivered to synapses at their input timepoints, and each of the synapses determines the magnitude of the signal (degree of influence) to be delivered to a membrane implemented at the dendrite of a neuron depending on its synaptic weight that stores the relationship between the corresponding axon (pre-synaptic neuron) and the neuron (post-synaptic neuron). Then, such signals are integrated in the membrane, whereby the corresponding neuron fires.

The above-described mechanism may be implemented using a semiconductor circuit composed of Metal-Oxide-Semiconductor Field-Effect Transistors (MOSFETs), so that synaptic operations may be expressed in the form of charge-based operations. The input of axons is connected to the gate of a MOSFET and the weight of a synapse is connected to the gates of MOSFETs connected in series to the MOSFET, so that the amount of current flowing through the two MOSFETs connected in series is adjusted, and the adjusted amount of current or charge is stored and accumulated in the membrane capacitor connected to the input of the neuron circuit such that the membrane potential is delivered to the neuron circuit.

Meanwhile, as the network size increases in a spike neural network implemented through a semiconductor circuit, the number of axon nodes for delivering input spikes to synapses and the number of output spike nodes increase, which results in an increase in the number of physical wires to connect the nodes to a digital domain. Particularly, when the implemented spike neural network chip is implemented as a single chip and when there is a separate digital chip that exchanges spike signals with the spike neural network chip, the burden of the number of physical wires causes the burden of the I/O count and the associated cost increase.

Therefore, conventional technology introduces a method for delivering spikes using addresses by implementing address encoders and decoders in a spike neural network that is implemented by expressing a corresponding axon and an output spike node through addresses, rather than expressing an input spike and an output spike as a one-to-one connection, as the network size increases.

In order for an analog-based spike neural network that operates asynchronously in response to input signals to exchange addresses with a digital domain that operates in synchronization with a clock, the analog-based spike neural network operates in a hand-shaking manner using not only address signals but also a request (REQ) signal and an acknowledgement (ACK) signal.

However, in order to enable the asynchronously delivered output spike addresses and REQ signal to be recognized in the digital domain, a high-speed sampling clock is used in the digital domain, which imposes a design burden for the use of the high-speed clock and causes an increase in power consumption and a design burden for asynchronous-synchronous timing between the spike neural network and the digital domain.

### SUMMARY OF THE INVENTION

An object of the disclosed embodiment is to achieve the effect of reducing power consumption by excluding the use of a high-speed clock and to facilitate the design of timing between an asynchronous spike neural network and a clock-synchronized digital domain by using an address decoder based on a memory structure when implementing an analog spike neural network circuit using a semiconductor.

An asynchronous spike counting interface apparatus according to an embodiment may include multiple counters, each of which counts the number of times each of neurons included in a spike neural network fires, and an address decoder for outputting an enable signal to a counter for counting the number of times a neuron corresponding to an address output from the spike neural network fires.

Here, the address decoder may include a table for storing binary values to be input to 2^{N} counters for each of addresses, which is configured with N bits.

Here, in response to input of the address output from the spike neural network, the address decoder may search the table for binary values corresponding to the input address and output the binary values to the multiple counters.

Here, when an output request signal is input from the spike neural network, the multiple counters may perform an operation of counting the enable signal output from the address decoder.

Here, the asynchronous spike counting interface apparatus according to an embodiment may further include a first delay device for delaying the output request signal, output from the spike neural network, by a first time and then inputting the same to each of the multiple counters.

Here, the asynchronous spike counting interface apparatus according to an embodiment may further include a second delay device for delaying an output request signal output from the first delay device by a second time and delivering the same to the spike neural network as an acknowledgement signal.

An asynchronous spike counting method in a spike neural network according to an embodiment may include decoding a counter enable signal corresponding to an address output from the spike neural network and counting the number of times each of neurons included in the spike neural network fires according to the decoded enable signal.

Here, decoding the counter enable signal may comprise decoding the address output from the spike neural network based on a table that stores binary values to be input to 2^{N} counters for each of addresses, which is configured with N bits.

Here, counting the number of times each of the neurons fires may comprise counting the decoded enable signal when an output request signal is input from the spike neural network.

Here, counting the decoded enable signal may comprise counting the decoded enable signal after delaying the output request signal output from the spike neural network by a first time.

Here, the asynchronous spike counting method according to an embodiment may further include delaying the output request signal delayed by the first time by a second time and then delivering the same to the spike neural network as an acknowledgement signal.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an exemplary view of a spike neural network (SNN) circuit that includes an address-based spike interface circuit;

FIG. 2 is a timing diagram for explaining a hand-shaking operation for the input address of an address-based spike interface circuit;

FIG. 3 is a timing diagram for explaining a hand-shaking operation for the output address of an address-based spike interface circuit;

FIG. 4 is a timing diagram for explaining the operations of a synapse and a neuron for spike input that passes through an address-based spike interface in a spike neural network (SNN) circuit;

FIG. 5 is a schematic circuit diagram of an asynchronous spike counting interface apparatus according to an embodiment;

FIG. 6 is a timing diagram for explaining the operation of the asynchronous spike counting interface circuit proposed in the present disclosure;

FIG. 7 is an exemplary view of a table stored in a memory-structure-based address decoder according to an embodiment;

FIG. 8 is a flowchart for signals in a memory-structure-based address decoder according to an embodiment;

FIG. 9 is a flowchart for explaining an asynchronous spike counting method in a spike neural network according to an embodiment; and

FIG. 10 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

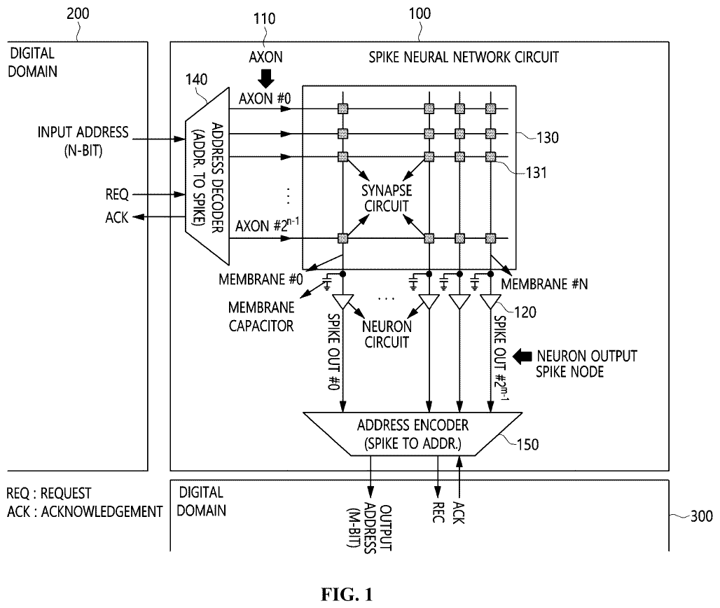

FIG. 1 is an exemplary view of a spike neural network (SNN) circuit that includes an address-based spike interface circuit.

Referring to FIG. 1, the spike neural network 100 generally includes axons 110 corresponding to the input of the network, neurons 120 corresponding to the output of the network, and multiple synapses 130 connecting the axons 110 and the neurons 120.

Here, the synapse 130 determines whether the axon 110 is connected to a dendrite, which is the input to the neuron 120, and the strength of the connection.

The input of a specific neuron 120 forms a dendrite and a membrane by collecting the results of applying the wight of each synapse 130, and the membrane accumulates the signals received from the synapses and delivers the signal as the input to the neuron.

The axon 110, which is the input of the network, is applied in the form of a pulse with short duration in the spike neural network 100.

Here, the degree of signal accumulation in the membrane, which serves as the input to the neuron, is determined by the interval at which pulses are applied. Also, the degree of signal accumulation in the membrane according to the input pulse of the unit axon 110 is determined depending on the synaptic weight that determines the correlation with a subsequent neuron for the input pulse in the synapse 130.

The membrane signal of a specific neuron is delivered as the input to the neuron 120 by collecting cumulative sums of the signals received from the dendrites connected to the same membrane and is compared with a reference potential (threshold) for the firing of the corresponding neuron 120, and then, depending on whether it exceeds the threshold, whether the neuron 120 is to fire is determined.

Meanwhile, as the size of the spike neural network 100 implemented with a semiconductor circuit increases, the number of axon nodes for delivering input spikes to synapses and the number of output spike nodes increase, which results in an increase in the number of physical wires for node connections with digital domains 200 and 300.

Conventional technology introduces a spike delivery method using addresses by implementing an address decoder 130 and an address encoder 140 in the spike neural network 100 that is implemented by expressing a corresponding axon node and an output spike node as addresses, rather than expressing an input spike and an output spike as a one-to-one connection, as the size of the spike neural network increases.

The analog-based spike neural network 100 operates asynchronously according to the input signal, so it operates in a hand-shaking manner using an address signal and additional request (REQ) and acknowledgement (ACK) signals in order to exchange addresses with the digital domains 200 and 300 that operate in synchronization with a clock.

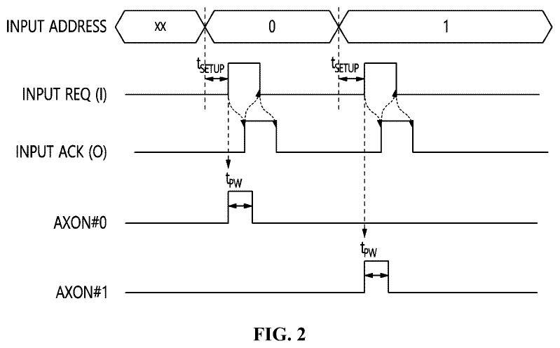

FIG. 2 is a timing diagram for explaining a hand-shaking operation for the input address of an address-based spike interface circuit.

FIG. 2 illustrates an input address and REQ and ACK signals for a hand-shaking operation between a digital domain and a spike neural network in order to deliver an input spike to an input axon through the address in an asynchronous analog-based spike neural network that does not use a clock.

In order to deliver the input address, the digital domain applies the address of the axon to which a spike is to be applied to an address port, and after a set delay time (t_{SETUP}), an input request (input REQ) is switched from LOW to HIGH.

t_{SETUP} indicates the setup time for latching an address at the rising edge of the request (REQ) in the address decoder circuit that converts the input address into an input spike.

The address decoder circuit receives the input request signal (Input REQ) from the digital domain, latches the input address to internal storage, and outputs an input acknowledgement signal (Input ACK) to the digital domain.

Simultaneously, a pulse with the pulse width of t_{PW} is generated and delivered to the input axon of the internal spike neural network. Upon receiving the input acknowledgement signal (Input ACK), the digital domain switches the input request signal (Input REQ), which was transmitted thereby, from HIGH to LOW, and at the moment when the input request signal (Input REQ) drops to LOW, the address decoder circuit switches the input acknowledgement signal (Input ACK) from HIGH to LOW, whereby the hand-shaking process for delivering the input address is terminated.

In FIG. 2, two axons (Axon #0 and Axon #1) are assumed, and it shows the timing of transmitting spikes for Axon #0 and Axon #1 by receiving address 0 and address 1.

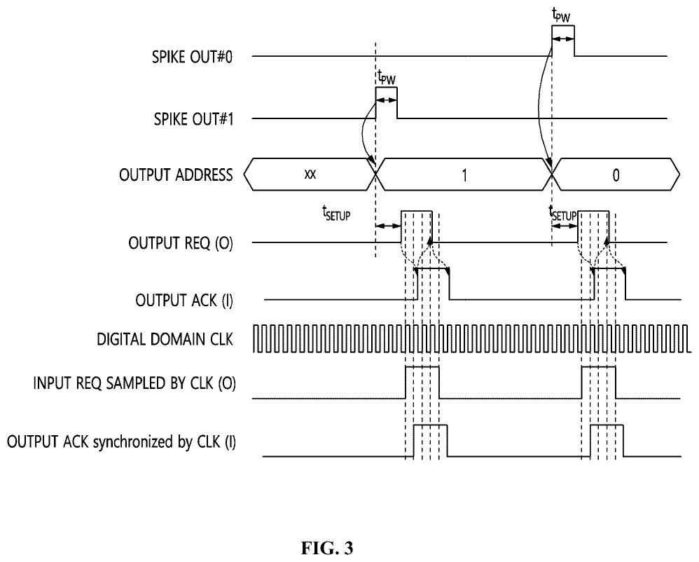

FIG. 3 is a timing diagram for explaining a hand-shaking operation for the output address of an address-based spike interface circuit.

Referring to FIG. 3, after a charge operation process is performed in a synapse and a membrane node in the analog spike neural network 100, when a spike is output through a neuron, it is converted into the address based on a corresponding output spike node through the implemented address encoder 140 when the spike is generated.

The output spike may have the pulse width of t_{PW}, and the spike-generating node delivers the value encoded into the address to the digital domain 300 via the output address node.

After a certain amount of delay time (t_{SETUP}) for the address latch to the storage space in the digital domain 300, an output request signal (Output REQ) is switched from LOW to HIGH, and the hand-shaking operation between the asynchronous analog address encoder 140 and the digital domain is initiated.

The asynchronous output request signal (Output REQ) delivered from the analog address encoder 140 is sampled by the internal clock of the digital domain 300 so as to be used as a clock-synchronized signal in the digital domain 300, and thus the output request signal (Output REQ(O)) sampled by CLK is used inside the digital domain 300.

When the digital domain 300 detects that the output request signal (Output REQ) input thereto is switched from LOW to HIGH, it latches the address delivered to the output address node at the corresponding time and increases the value of the internal counter indicated by the address by 1. Simultaneously, an output acknowledgement signal (Output ACK) synchronized by CLK is delivered to the address encoder 140 in the analog spike neural network 100, and the address encoder 140 detects this signal and switches the output request signal (Output REQ) from HIGH to LOW.

The digital domain 300 detects the switched output request signal (Output REQ) and switches the output acknowledgement signal (Output ACK) from HIGH to LOW, thereby terminating the hand-shaking process for delivering the final output address.

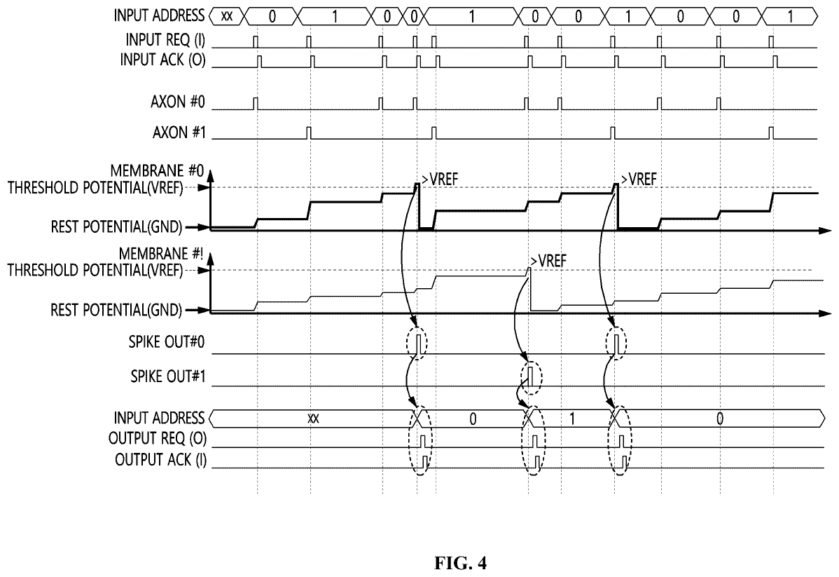

FIG. 4 is a timing diagram for explaining the operations of a synapse and a neuron for the spike input that passes through an address-based spike interface in a spike neural network (SNN) circuit.

Spikes are applied to Axon #0 and Axon #1 through the address conversion process for the input spike and the hand-shaking process, which are described in FIG. 2, and charge accumulation occurs in the membrane capacitor implemented at the input to the neuron when the spike is input. The amount of charge accumulated is determined depending on the weight stored in the synapse, which is the connection part of each axon and the neuron.

Referring to FIG. 4, spikes that are input to Axon #0 and Axon #1 at different times are illustrated, and the increased amounts of membrane potentials depending on different weights of Axon #0 and Axon #1 are shown based on the time at which each of the spikes is input. That is, in the case of membrane #0, the increase in the membrane potential value when a spike is input to Axon #1 is greater than when a spike is input to Axon #0, which indicates that the weight stored in Axon #1 is greater than that stored in Axon #0 for neuron #0 where spike out #0 is generated. The membrane potential of membrane #1 also increases depending on the corresponding membrane and the weights of Axon #0 and Axon #1. The membrane potential increases at the time of applying the input spike to each axon, and when the membrane voltage exceeds the threshold voltage of the neuron, the neuron fires and emits the output spike, after which the membrane voltage returns to the initial value (GND) by the neuron reset signal that is input. Depending on the weight stored in the synapse and the time at which the input spike is applied, the frequency and timing of the spike output from the neuron vary.

When an output spike of each neuron occurs, the output address, which is acquired by encoding the number of the neuron, and an output request signal (Output REQ) based thereon are output, as illustrated in FIG. 3. At the reception side of the digital domain 300, the output request signal (Output REQ) is received, and the output acknowledge signal (Output ACK) is delivered to the spike neural network 100. In this process, the asynchronous analog address encoder 140 is not able to send and receive signals at the timing synchronized with the clock signal of the digital domain, so the conventional technology provides a high-speed sampling clock in the digital domain so as to sample the received output request signal (Output REQ), stores the received output address based on the sampled signal in the internal latch of the digital domain, and increases the value of the counter implemented in the digital domain to match the number of fired spikes after decoding the synchronized address. Accordingly, the high-speed sampling clock is used in the digital domain in order to enable the asynchronously delivered output spike address and request (REQ) signal to be recognized in the digital domain, which makes the design burden for the use of the high-speed clock, causes an increase in power consumption, and makes the burden of designing asynchronous-synchronous timing between the spike neural network and the digital domain.

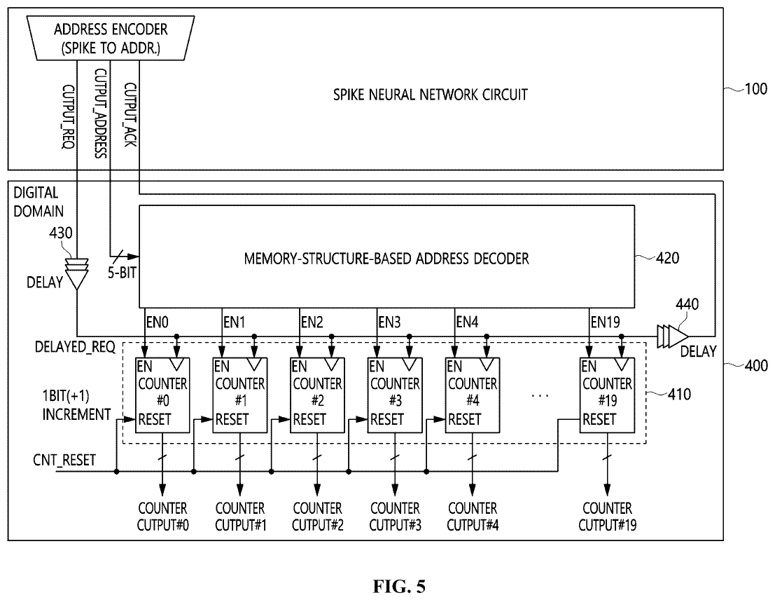

FIG. 5 is a schematic circuit diagram of an asynchronous spike counting interface apparatus according to an embodiment.

Referring to FIG. 5, based on the hand-shaking operation for the output address of an address-based spike interface circuit, the asynchronous spike neural network 100 encodes the address of the firing neuron into a binary format (150) in order to deliver the output spike information to the digital domain 400, delivers the output address along with the output request signal (Output REQ), and receives an output acknowledgement signal (Output ACK) from the digital domain, thereby performing the hands-shaking operation.

The asynchronous spike counting interface apparatus according to an embodiment may include multiple counters 410 for counting the number of times each of the neurons included in the spike neural network 100 fires in the digital domain 400 and an address decoder 420 for outputting an enable signal to the counter for counting the number of times the neuron corresponding to the address output from the spike neural network 100 fires.

Here, the address decoder 420 may include a table that stores binary values to be input to 2^{N} counters for each of the addresses, which is configured with N bits.

Accordingly, the memory-structure-based address decoder 420 may search the table stored therein for binary values corresponding to the output address delivered from the asynchronous spike neural network 100 to the digital domain and may output the found binary values to the counters 410. That is, the binary values are delivered to the enable terminals of the counters 410 that correspond to the neurons in the digital domain in a one-to-one manner.

The multiple counters 410 perform the operation of counting the enable signal output from the address decoder 420 when the output request signal is input from the spike neural network 100.

Here, the asynchronous spike counting interface apparatus according to an embodiment may further include a first delay device 430 that delays the output request signal output from the spike neural network by a first time and inputs the same to each of the multiple counters.

Accordingly, each of the multiple counters 410 is synchronized to the delayed REQ signal, which is a delayed version of the output request (Output REQ) delivered from the asynchronous spike neural network 100, and increments the count value by 1.

Also, the asynchronous spike counting interface apparatus according to an embodiment may further include a second delay device 440 that delays the output request signal output from the first delay device 430 by a second time and delivers the same to the spike neural network as an acknowledgement signal.

The use of the memory-structure-based address decoder 420 according to an embodiment enables a digital circuit to be designed in a standardized form or provided according to the specifications given by a semiconductor manufacturer, so the delay time for address decoding is predictable at design time and may be given as a design timing condition.

In general, when designing a synchronized digital circuit, the relative setup/hold time (tsetup/thold) between the clock signal applied to flip-flops or synchronous circuits implemented within the circuit and the data signal that is sampled by the clock signal is very important, and in the case of a conventional asynchronous-synchronous interface circuit, it is difficult to design the circuit because it is impossible to accurately predict the timing of the address decoder implemented in the digital domain.

However, the asynchronous spike counting interface apparatus according to an embodiment includes the memory-structure-based address decoder 420, so the address decoding time based on the timing specification guaranteed by the semiconductor manufacturer may be secured, and because each counter is synchronized based on the delayed REQ, only the timing condition of the circuit part that is implemented in the digital domain to delay the output request signal (Output REQ) is considered at the design time.

The digital domain 400 is configured to count the output spikes for a certain time period using the counter 410 and to take the number of spikes of each neuron, which is stored in the final counter, rather than delivering the real-time output spike information from the asynchronous spike neural network 100 to the remaining part of the digital domain, and the operation of taking the value of the counter may be performed based on a main clock that is used for the operation in the digital domain 400.

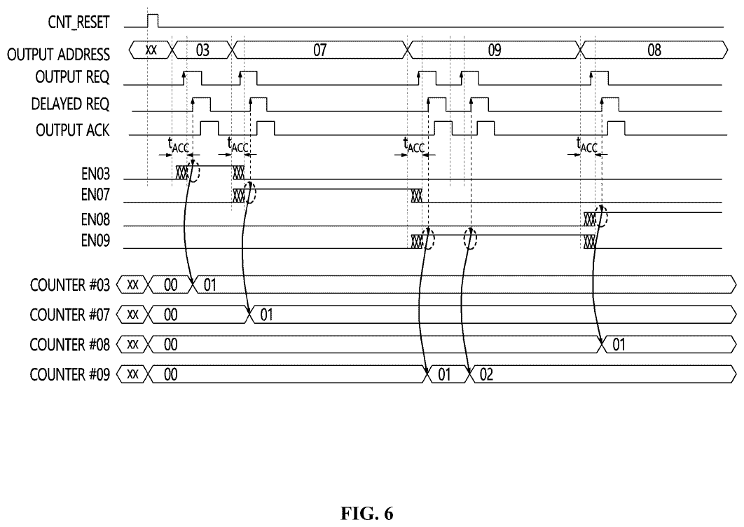

FIG. 6 is a timing diagram for explaining the operation of an asynchronous spike counting interface circuit according to an embodiment.

Referring to FIG. 6, all the values of spike counters that are implemented in a digital domain to correspond to respective neurons are reset by a CNT_RESET pulse, whereby initialization is completed. Subsequently, a hand-shaking operation for the input address delivered from the digital domain to the asynchronous spike neural network is performed, and the spike neural network performs a charge-based operation in the same manner as FIG. 4. When a spike occurs in a specific neuron depending on the result of the charge-based operation, the address encoder within the asynchronous spike neural network encodes the spike into an address and delivers the address to the digital domain.

The memory-structure-based address decoder 420 in the digital domain reads the memory value of the address using the received address and delivers the same as the output.

In FIG. 6, neuron 3 fires, so ‘output address=03’ received from the asynchronous spike neural network is input to the memory-structure-based address decoder 420. As a result, EN03, which is the corresponding memory value, is set to HIGH and is then output.

Here, the memory-structure-based address decoder 420 outputs EN03 no later than access time (t_{ACC}) after applying the address according to the access time (t_{ACC}) specification for the memory structure provided by the semiconductor manufacturer.

After an output request signal (Output REQ) is received from the asynchronous spike neural network 100, a delayed REQ is generated internally in the digital domain, and because the access time (t_{ACC}) of the memory-structure-based address decoder 420 is guaranteed, the designer only needs to reflect the timing condition in the design such that the rising edge of the delayed REQ occurs after t_{ACC}.

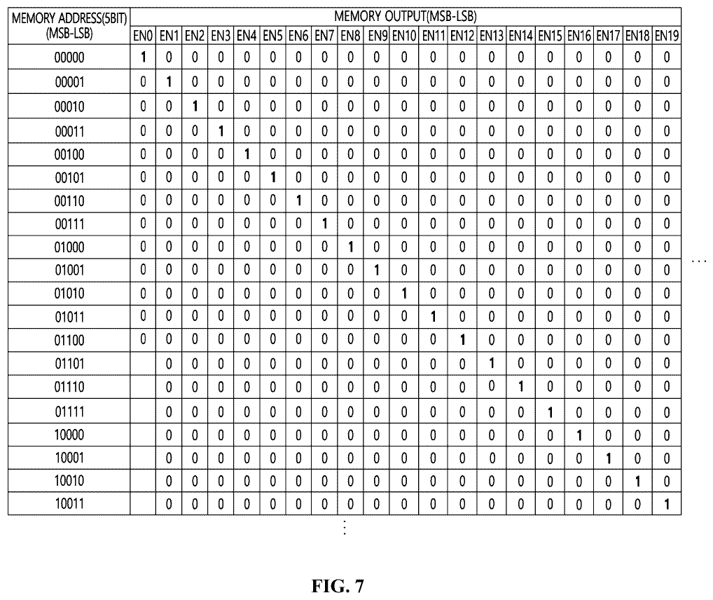

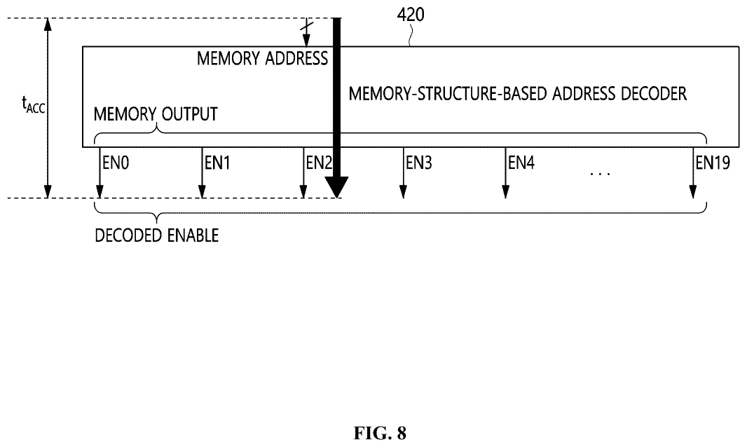

FIG. 7 is an exemplary view of a table stored in a memory-structure-based address decoder according to an embodiment, and FIG. 8 is a flowchart for signals in a memory-structure-based address decoder according to an embodiment.

Referring to FIG. 7, the memory-structure-based address decoder 420 receives the output address delivered from the asynchronous spike neural network and delivers the value stored in the memory as the enable signal of each spike counter, and the value stored in the memory for each address is configured such that only one enable signal is set to HIGH.

Therefore, all enable values, excluding the corresponding enable value, are LOW, and only one specific spike counter is enabled for a specific address, so the value of the corresponding counter is incremented at the rising edge of the delayed REQ signal that is delivered.

Referring to FIG. 8, because the memory structure can be provided in a structure standardized by the semiconductor manufacturer, the access time (t_{ACC}) may be provided as a specification, and the designer may reflect the timing condition of the delayed REQ signal in the design by referring to the provided specification for t_{ACC}.

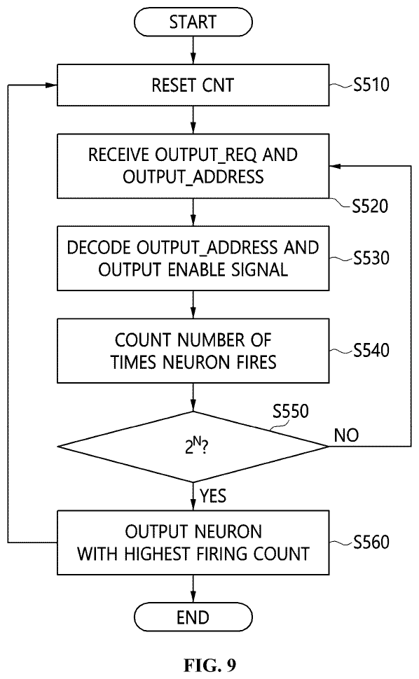

FIG. 9 is a flowchart for explaining an asynchronous spike counting method in a spike neural network according to an embodiment.

Referring to FIG. 9, the asynchronous spike counting method in a spike neural network according to an embodiment may include decoding a counter enable signal corresponding to an address output from the spike neural network at step S530 and counting the number of times each of neurons included in the spike neural network fires according to the decoded enable signal at step S540.

First, all of the values of spike counters that are implemented in the digital domain to correspond to the respective neurons are reset by the CNT_RESET pulse, whereby initialization is completed at step S510.

Subsequently, a hand-shaking operation corresponding to the input address from the digital domain 400 to the asynchronous spike neural network is performed, and the spike neural network 100 performs a charge-based operation.

When a spike occurs in a specific neuron depending on the result of the charge-based operation, the address encoder within the asynchronous spike neural network 100 encodes the spike into an address and delivers the address to the digital domain 400.

Here, the digital domain 400 receives the output address from the asynchronous spike neural network 100 along with an output request signal (Output REQ) at step S520.

Meanwhile, decoding the counter enable signal at step S530 according to an embodiment may comprise decoding the address output from the spike neural network based on a table that stores binary values to be input to 2^{N} counters for each of addresses, which is configured with N bits.

Also, counting the number of times each of the neurons fires at step S540 according to an embodiment may comprise counting the decoded enable signal when the output request signal is input from the spike neural network.

Here, counting the number of times each of the neurons fires at step S540 may comprise counting the decoded enable signal after delaying the output request signal from the spike neural network by a first time.

Also, steps S520 to S540 may be repeatedly performed according to an embodiment. Then, the neuron with the highest firing count, which is calculated by repeatedly performing the steps, is output at step S560.

Also, the asynchronous spike counting method in a spike neural network according to an embodiment may further include delaying the output request signal delayed by the first time by a second time and delivering the same to the spike neural network as an acknowledgement signal.

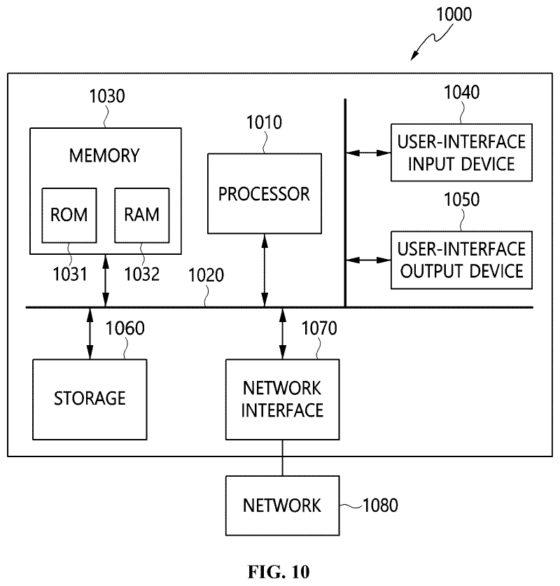

FIG. 10 is a view illustrating a computer system configuration according to an embodiment.

The asynchronous spike counting interface apparatus according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, a spike neural network circuit based on asynchronous analog charge-based operations is implemented to operate in an asynchronous hand-shaking manner by including an address decoder based on a memory structure and a counter operating at the rising edge of a request (REQ) signal in an interface circuit, instead of using a high-speed sampling clock, in order to recognize asynchronously delivered output spike addresses and REQ signal in a digital domain that exchanges signals with the spike neural network circuit. Accordingly, a design burden caused by the use of a high-speed clock in the digital domain may be reduced, and power consumption may be reduced by not using the high-speed clock. Also, the use of the memory-structure-based address decoder has the effect of facilitating the design of timing between the asynchronous spike neural network and the clock-synchronized digital domain.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An asynchronous spike counting interface apparatus, comprising:
multiple counters, each counting a number of times each of neurons included in a spike neural network fires; and
an address decoder for outputting an enable signal to a counter for counting a number of times a neuron corresponding to an address output from the spike neural network fires.

2. The asynchronous spike counting interface apparatus of claim 1, wherein the address decoder includes a table that stores binary values to be input to 2^{N} counters for each of addresses, which is configured with N bits.

3. The asynchronous spike counting interface apparatus of claim 2, wherein, in response to input of the address output from the spike neural network, the address decoder searches the table for binary values corresponding to the input address and outputs the binary values to the multiple counters.

4. The asynchronous spike counting interface apparatus of claim 1, wherein, when an output request signal is input from the spike neural network, the multiple counters perform an operation of counting the enable signal output from the address decoder.

5. The asynchronous spike counting interface apparatus of claim 4, further comprising:
a first delay device for delaying the output request signal, output from the spike neural network, by a first time and inputting the delayed output request signal to each of the multiple counters.

6. The asynchronous spike counting interface apparatus of claim 5, further comprising:
a second delay device for delaying an output request signal output from the first delay device by a second time and delivering the delayed output request signal to the spike neural network as an acknowledgement signal.

7. An asynchronous spike counting method in a spike neural network, comprising:
decoding a counter enable signal corresponding to an address output from the spike neural network; and
counting a number of times each of neurons included in the spike neural network fires according to the decoded enable signal.

8. The asynchronous spike counting method of claim 7, wherein decoding the counter enable signal comprises decoding the address output from the spike neural network based on a table that stores binary values to be input to 2^{N} counters for each of addresses, which is configured with N bits.

9. The asynchronous spike counting method of claim 7, wherein counting the number of times each of the neurons fires comprises counting the decoded enable signal when an output request signal is input from the spike neural network.

10. The asynchronous spike counting method of claim 9, wherein counting the decoded enable signal comprises counting the decoded enable signal after delaying the output request signal output from the spike neural network by a first time.

11. The asynchronous spike counting method of claim 10, further comprising:
delaying the output request signal, which is output after being delayed by the first time, by a second time and delivering the delayed signal to the spike neural network as an acknowledgement signal.
